(19) United States
(12) Patent Application Publication
(10) Pub. No.: US 2013/0050284 A1
(43) Pub. Date: Feb. 28, 2013

(54) DISPLAY DEVICE AND ELECTRONIC UNIT

(71) Applicant: Yoshihisa Sato, Saitama (JP)

(72) Inventor: Yoshihisa Sato, Saitama (JP)

(73) Assignee: Sony Corporation, Tokyo (JP)

(21) Appl. No.: 13/560,773

(22) Filed: Jul. 27, 2012

(30) Foreign Application Priority Data
Aug. 30, 2011 (JP) 2011-187456

(51) Int. Cl. G09G 5/10

(52) U.S. Cl. 345/690

(57) ABSTRACT

A display device includes: a display section including a plurality of pixels, and displaying a plurality of perspective images assigned to the pixels; and a plurality of selectors each selecting any from among the perspective images traveling in respective angle directions from the pixels, in which light transmittance of each of the selectors is non-uniform in time or space.

### BACKGROUND

The present disclosure relates to a display device performing stereoscopic display, and an electronic unit including such a display device.

Imaging units performing stereoscopic display with naked eyes with use of a parallax barrier have been widely known. The parallax barrier has opening sections located at given intervals. When a user views an image display section through the parallax barrier, different image signals enter the right eye and the left eye of the user, respectively. The right eye and the left eye view different images, respectively, thereby achieving stereoscopic vision with naked eyes.

### SUMMARY

Although a parallax barrier system is allowed to achieve stereoscopic vision with naked eyes in a simple way, the parallax barrier system has the following issue. In the case where an image display section includes a plurality of pixels two-dimensionally arranged, and displays an image as in the case of a liquid crystal display panel or a plasma display device, a moiré phenomenon may occur in the parallax barrier system. In this phenomenon, a difference in intervals between the pixels of the image display section and opening sections of a parallax barrier causes a beat, thereby resulting in moiré. Moiré has been known as degradation in image quality which causes extreme discomfort, since luminance periodically varies to cause a stripe pattern on a displayed image. Japanese Unexamined Patent Application Publication No. 2004-118140 discloses a technique of eliminating moiré.

In Japanese Unexamined Patent Application Publication No. 2004-118140, it is reported that color moiré is reduced when a barrier interval (s1 or s2) and a pixel pitch (p) satisfy the following expressions.

s1=(n+0.5)p, where n is an integer

s2=(n+k/3)p, where k=1 or 2

At this time, since sub-pixels are configured of sub-pixels of three colors RGB, p=3 pp is established, where a sub-pixel pitch is pp.

A paragraph [0049] in Japanese Unexamined Patent Application Publication No. 2004-118140 describes as follows.

“With regard to a mark 41G, it is clear that lines with a same color which are indicated by the mark 41G and are formed in a vertical direction are repeatedly formed in a horizontal direction at predetermined intervals 2s1. In other words, when the expression (1) is satisfied, color moiré has a minimum possible interval which is twice as wide as the pattern interval s1. This minimum possible interval is sufficiently narrow as intervals of moiré fringes; therefore, color moiré is less likely to be perceived, and a stereoscopic image with high image quality is allowed to be displayed.”

As described in the paragraph [0049] in Japanese Unexamined Patent Application Publication No. 2004-118140, the issue of color moiré is solved by setting the interval of color moiré to 2s1. However, even though the interval of moiré is reduced, the occurrence of moiré is not radically eliminated. Moreover, Japanese Unexamined Patent Application Publication No. 2004-118140 aims to reduce color moiré; therefore, moiré which is caused by luminance variations is not reduced.

It is desirable to provide a display device and an electronic unit which are allowed to achieve image display with high image quality and less moiré.

According to an embodiment of the disclosure, there is provided a display device including: a display section including a plurality of pixels, and displaying a plurality of perspective images assigned to the pixels; and a plurality of selectors each selecting any from among the perspective images traveling in respective angle directions from the pixels, in which light transmittance of each of the selectors is non-uniform in time or space.

According to an embodiment of the disclosure, there is provided an electronic unit including a display device, the display device including: a display section including a plurality of pixels, and displaying a plurality of perspective images assigned to the pixels; and a plurality of selectors each selecting any from among the perspective images traveling in respective angle directions from the pixels, in which light transmittance of each of the selectors is non-uniform in time or space.

In the display device or the electronic unit according to the embodiment of the disclosure, light transmittance of each of the selectors is non-uniform in time or space to select any from among the perspective images traveling in respective angle directions from the pixels.

In the display device or the electronic unit according to the embodiment of the disclosure, light transmittance of each of the selectors is non-uniform in time or space; therefore, an image with high image quality and less moiré is allowed to be displayed.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a display device according to a first embodiment of the disclosure.

FIG. 2 is an external perspective view illustrating a configuration example of an image display section and a parallax generation section.

FIG. 3 is a side view illustrating a configuration example of the image display section and the parallax generation section.

FIG. 4 is a plan view illustrating a configuration example of the image display section.

FIG. 5 is a plan view illustrating a configuration example of the parallax generation section (a liquid crystal barrier).

FIG. 6 is a side view illustrating a configuration example of the parallax generation section (the liquid crystal barrier).

FIG. 7 is an explanatory diagram illustrating a principle of stereoscopic display.

FIG. 8 is an explanatory diagram illustrating a relationship between opening section intervals and pixel intervals.

FIG. 9 is a sectional view illustrating an example of grouping of opening sections of the liquid crystal barrier.

FIG. 10 is a plan view illustrating an example of grouping of the opening sections of the liquid crystal barrier.

FIG. 11 is a sectional view illustrating a first state of the opening section.

FIG. 12 is a sectional view illustrating a second state of the opening section.

FIG. 13 is an explanatory diagram illustrating a light-converging state of light beams when opening sub-sections A1 and A2 are in transmission state and a light-conversing state of light beams when opening sub-sections A2 and A3 are in transmission state.

FIG. 14 is an explanatory diagram of occurrence of moiré.

FIG. 15 is an explanatory diagram illustrating a state of perspective images viewed from a view position P2 located farther from an optimum viewing distance.

FIG. 16 is an explanatory diagram illustrating a light-converging state when only the opening sub-sections A1 and A2 are in transmission state.

FIG. 17 is an explanatory diagram illustrating a state of perspective images viewed from the view position P2 located farther from the optimum viewing distance when only the opening sub-sections A1 and A2 are in transmission state.

FIG. 18 is an explanatory diagram illustrating a light-converging state when only the opening sub-sections A2 and A3 are in transmission state.

FIG. 19 is an explanatory diagram illustrating a state of perspective images viewed from the view position P2 located farther from the optimum viewing distance when only the opening sub-sections A2 and A3 are in transmission state.

FIG. 20 is an explanatory diagram illustrating an example of variations in light transmittance of the opening section with time.

FIGS. 21A to 21C illustrate explanatory diagrams, where FIG. 21A illustrates a state of perspective images viewed from the view position P2 located farther from the optimum viewing distance when only the opening sub-sections A1 and A2 are in transmission state, FIG. 21B illustrates a state of perspective images viewed from the view position P2 located farther from the optimum viewing distance when only the opening sub-sections A2 and A3 are in transmission state, and FIG. 21C illustrates a superimposing of the state of perspective images in FIG. 21A on the state of perspective images in FIG. 21B.

FIGS. 22A to 22C are explanatory diagrams, where FIG. 21A illustrates a luminance distribution viewed from the view position P2 located farther from the optimum viewing distance when only the opening sub-sections A1 and A2 are in transmission state, FIG. 22B illustrates a luminance distribution viewed from the view position P2 when only the opening sub-sections A2 and A3 are in transmission state, and FIG. 22C illustrates a superimposing of the luminance distribution in FIG. 22A on the luminance distribution in FIG. 22B.

FIG. 23 is a sectional view illustrating a first example when light transmittance of the opening section varies in space.

FIG. 24 is a sectional view illustrating a second example when light transmittance of the opening section varies in space.

FIG. 25 is an explanatory diagram illustrating an embodiment in which the parallax generation section (the liquid crystal barrier) is disposed between a backlight and the image display section.

FIG. 26 is an explanatory diagram illustrating an embodiment in which the technology of the disclosure is applied to an integral imaging system.

FIG. 27 is an explanatory diagram, where parts (A) and (B) illustrate a first state and a second state, respectively, in the case where the parallax generation section is configured of a lenticular lens.

FIG. 28 is an external view illustrating an example of an electronic unit.

### DETAILED DESCRIPTION OF THE PREFERRED EMBODIMENTS

Preferred embodiments of the disclosure will be described in detail below referring to the accompanying drawings.

### First Embodiment

### [Whole Configuration of Display Device]

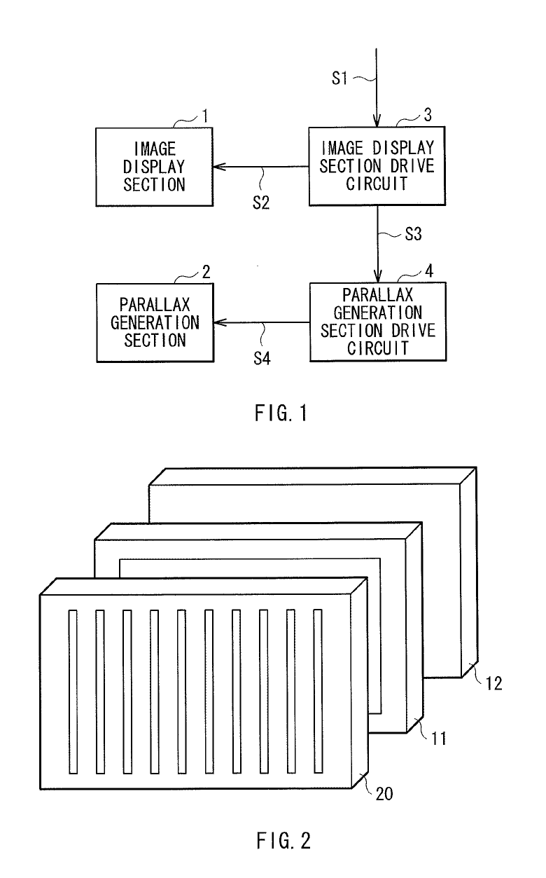

FIG. 1 illustrates a configuration example of a display device according to a first embodiment of the disclosure. The display device includes an image display section 1, a parallax generation section 2, an image display section drive circuit 3, and a parallax generation section drive circuit 4.

A parallax image signal S1 is supplied from an external unit to the image display section drive circuit 3. The parallax image signal S1 is an image signal with parallax varying with depth of stereoscopic information in a stereoscopic image to be reproduced. The number of parallax image signals 51 equal to the number of perspectives which will be described later are supplied to the image display section drive circuit 3. The image display section drive circuit 3 rearranges the order of the parallax image signals S1 to produce an image signal S2. The image signal S2 is supplied to the image display section 1. Moreover, the image display section drive circuit 3 transmits, to the parallax generation section drive circuit 4, a synchronization signal S3 corresponding to the supplied image signal S2. The parallax generation section drive circuit 4 transmits a parallax generation signal S4 to the parallax generation section 2 in response to the synchronization signal S3 to drive the parallax generation section 2. The parallax generation signal S4 corresponds to the image signal S2 to be displayed by the image display section 1. The parallax generation section 2 performs an operation in response to the parallax generation signal S4.

### [Configuration Examples of Image Display Section 1 and Parallax Generation Section 2]

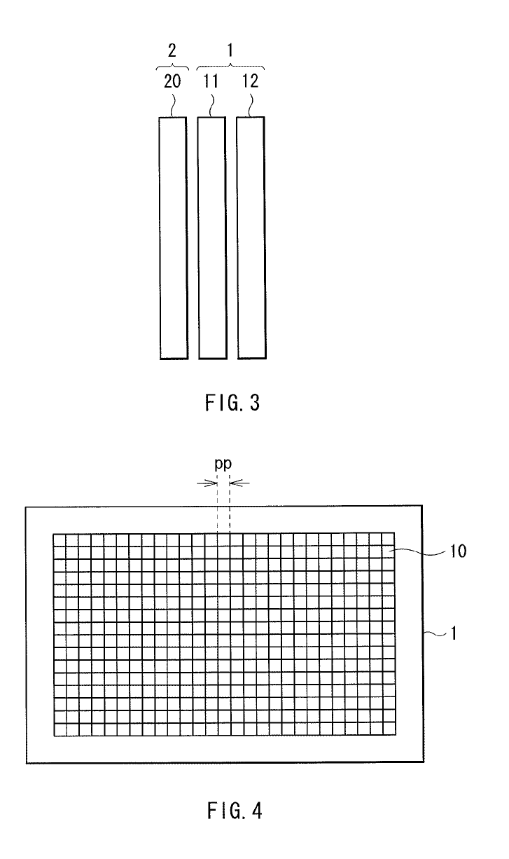

FIGS. 2 and 3 illustrate configuration examples of the image display section 1 and the parallax generation section 2. The image display section 1 displays an image on a two-dimensional plane. FIGS. 2 and 3 each illustrate an example in which the image display section 1 is configured of a combination of a liquid crystal panel 11 and a backlight 12; however, the image display section 1 may be configured of an electroluminescent panel or the like. The parallax generation section 2 is disposed between the image display section 1 and a viewer, and light emitted from the image display section 1 enters the parallax generation section 2. The parallax generation section 2 is configured of a parallax barrier (a liquid crystal barrier 20) capable of controlling light transmittance by a liquid crystal material.

As illustrated in FIG. 4, the image display section 1 includes a plurality of pixels 10 arranged on a two-dimensional plane. Respective pixels 10 are allowed to independently vary luminance, and are allowed to arbitrarily display an image. An image is displayed on each pixel 10 based on the image signal S2 from the image display section drive circuit 3 (refer to FIG. 1). A pixel interval in a horizontal direction (a horizontal pixel interval) is represented by pp.

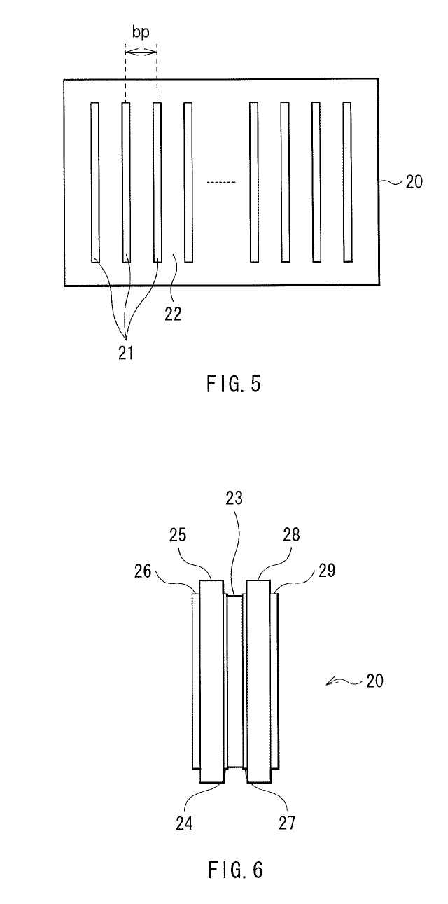

FIGS. 5 and 6 each illustrate a specific configuration example of the liquid crystal barrier 20 as the parallax generation section 2. As illustrated in FIG. 5, the liquid crystal barrier 20 includes a plurality of slit-like opening sections 21 extending in a vertical direction. Sections between the plurality of opening sections 21 are shielding sections 22 not allowing light to pass therethrough. The opening sections 21 each have a function as a traveling angle selection section selecting any from among light of perspective images from the pixels 10 of the image display section 1 to emit the selected light. The opening sections 21 each select any from among perspective images traveling toward the viewer based on a positional relationship between the pixels 10 and the opening sections 21. Details will be given later.

As illustrated in FIG. 6, the liquid crystal barrier 20 includes a liquid crystal material 23, a first transparent electrode 24, a first transparent parallel plate 25, a first polarizing plate 26, a second transparent electrode 27, a second transparent parallel plate 28, and a second polarizing plate 29.

The liquid crystal material 23 is sealed between the first transparent parallel plate 25 and the second transparent parallel plate 28. The first transparent electrode 24 made of ITO (Indium Tin Oxide) or the like is disposed on a surface located closer to the liquid crystal material 23 of the first transparent parallel plate 25. Likewise, the second transparent electrode 27 is disposed on a surface located closer to the liquid crystal material 23 of the second transparent parallel plate 28. In the liquid crystal barrier 20, the alignment of the liquid crystal material 23 varies in response to a voltage applied to the first transparent electrode 24 and the second transparent electrode 27. When light from the image display section 1 passes through the first polarizing plate 26, the light is linearly polarized. When the light passes through the liquid crystal material 23, the direction of polarization is allowed to be controlled by the alignment of the liquid crystal material 23. Then, when the light passes through the second polarizing plate 29, intensity modulation is allowed to be performed. For example, the liquid crystal barrier 20 performs a so-called normally black operation in which light passes therethrough under voltage application and light is shielded under no voltage application. Moreover, the liquid crystal barrier 20 may perform a so-called normally white operation in which light is shielded under voltage application and light passes therethrough under voltage application. It is to be noted that the shielded light is absorbed by the second polarizing plate 29 in the case where the second polarizing plate 29 is an absorption type polarizing plate. In the case where the second polarizing plate 29 is a reflection type polarizing plate, the light returns to the image display section 1.

### [Operation of Display Device]

In the display device, the image display section 1 displays a number n of perspective images assigned to the pixels 10, where n is an integer. A plurality of traveling angle selection sections (opening sections 21) each select any from among the perspective images traveling in respective angle directions from the pixels 10. The parallax generation section drive circuit 4 switches, with time, the plurality of traveling angle selection sections into one of first to mth states in synchronization with the image display section drive circuit 3 at, for example, predetermined intervals.

The parallax generation section drive circuit 4 switches, with time, the plurality of opening sections 21 into one of the first to mth states to allow a traveling angle of a perspective image to vary from one state to another.

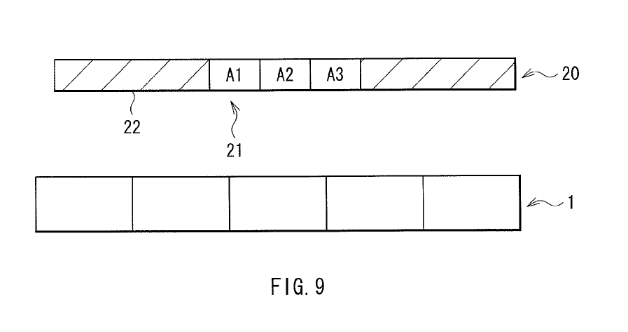

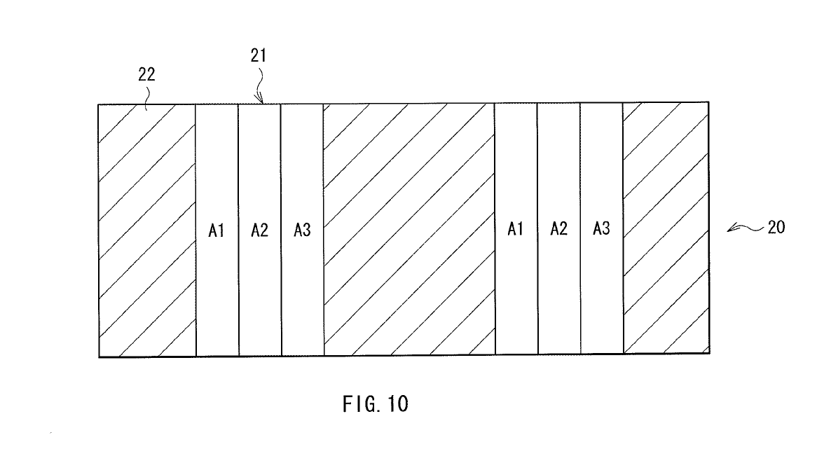

A specific example of an operation to switch the states of the plurality of opening sections 21 of the liquid crystal barrier 20 will be described below. As illustrated in FIG. 5, the opening sections 21 each have a slit-like shape, and an interval between the opening sections 21 is bp. Moreover, each of the opening sections 21 has a plurality of sub-regions, and the parallax generation section drive circuit 4 varies light transmittance with time in each of the sub-regions. In this description, as illustrated in FIGS. 9 and 10, each of the opening sections 21 has first to third sub-regions (opening sub-sections A1, A2, and A3) in a horizontal direction. In the liquid crystal barrier 20, a group of opening sub-sections A1 (an opening sub-section group A1), a group of opening sub-sections A2 (an opening sub-section group A2), and a group of opening sub-sections A3 (an opening sub-section group A3) each are allowed to vary light transmittance.

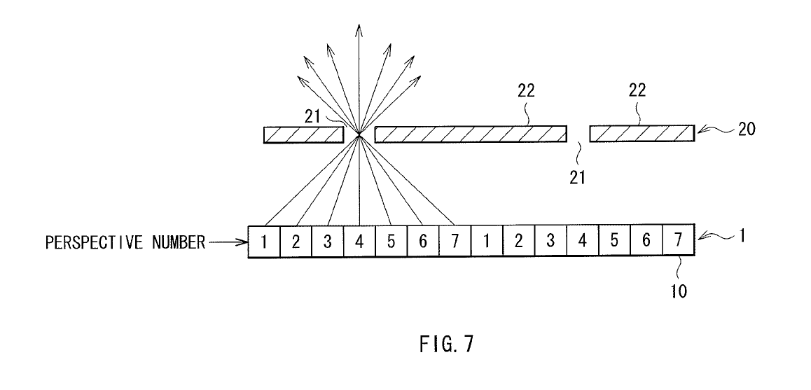

Next, a principle to achieve stereoscopic display will be described referring to FIG. 7. FIG. 7 corresponds to a sectional view of FIG. 2. Here, for example, only the opening sub-section group A2 is in transmission state, and other opening sub-section groups A1 and A3 are in a light-shielding state. Each of the opening sub-sections A2 is located in the middle of each of the opening sections 21. A traveling angle of light emitted from the pixels 10 of the image display section 1 is selected by the opening sub-section group A2 of the light crystal barrier 20. In FIG. 7, the opening sub-sections A2 are disposed in positions corresponding to every seven pixels. Numbers 1 to 7 assigned to respective pixels 10 indicate perspective numbers in stereoscopic vision. Perspective images for a same perspective number are displayed on pixels 10 to which the perspective number is assigned. The traveling angles of perspective images are selected by the opening sections 21 being in the transmission state in the liquid crystal barrier 20 to allow different perspective images to enter right and left eyes of the viewer. Thus, stereoscopic display is allowed to be performed.

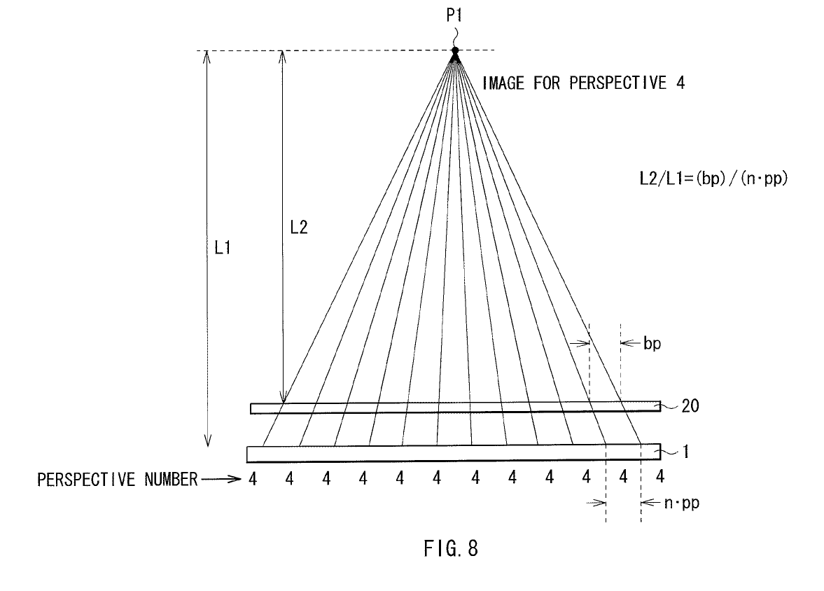

FIG. 8 illustrates a relationship between an interval by between opening sub-sections belonging to a same opening sub-section group, the perspective number n, and an interval pp between the pixels 10 of the image display section 1. At a distance L2 (an optimum viewing distance) from the liquid crystal barrier 20, perspective images for a same perspective from the entire surface of the image display section 1 are focused on a light-convergence position P1. In an example in FIG. 8, a light-converging state of perspective images for a perspective number 4 is illustrated. When the viewer is located at the distance L2 from the liquid crystal barrier 20, each eye of the viewer is allowed to view one perspective image as a whole. As different perspective images enter the right and left eyes, respectively, stereoscopic display is allowed to be performed.

The opening sub-sections belonging to a same sub-section group allow perspective images for a same perspective to be focused on one point at the optimum viewing distance L2. Therefore, a value of n·pp which is a result of multiplying the perspective number n by the pixel interval pp in the image display section 1 is different from and larger than the interval by between the opening sub-sections belonging to the same opening sub-section group. L2/L1=(bp)/(n·pp) is established, where L1 is a result of adding the optimum viewing distance L2 to a distance between the liquid crystal barrier 20 and the image display section 1.

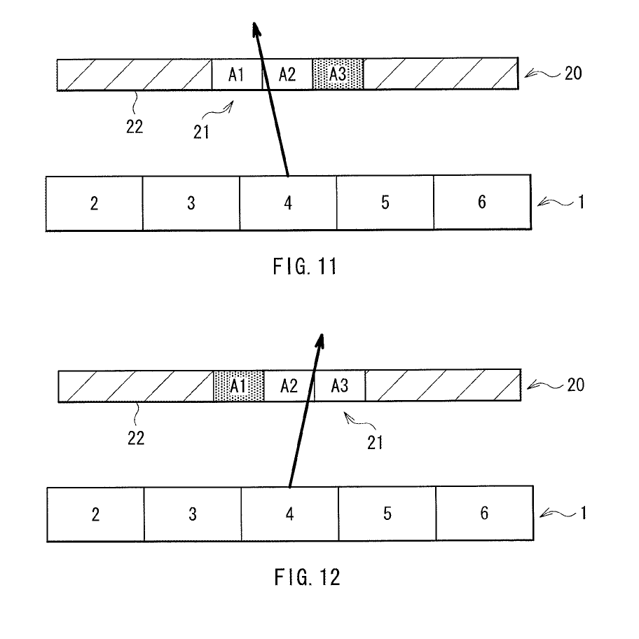

In this display device, the opening sections 21 are switched, with time, into one of the first to mth states. For example, the opening sections 21 is switched, with time, into one of two states, i.e., a first state illustrated in FIG. 11 and a second state illustrated in FIG. 12. In this case, FIG. 11 illustrates a relationship between each opening section and a perspective image when the opening sub-section groups A1 and A2 are in transmission state, and the opening sub-section group A3 is in transmission state (a shielding state). FIG. 12 illustrates a relationship between each opening section and a perspective image when the opening sub-section groups A2 and A3 are in the transmission state and the opening sub-section group A1 is in the non-transmission state (the shielding state). A positional relationship between the pixels 10 and the opening sections 21 in the transmission state differs between the first state in FIG. 11 and the second state in FIG. 12. In the first state in FIG. 11, the opening sub-sections A1 and A2 which are in the transmission state are located at the upper left of a pixel to which the perspective number 4 is assigned. However, in the second state in FIG. 12, the opening sub-sections A2 and A3 which are in the transmission state are located at the upper right of the pixel to which the perspective number 4 is assigned. Therefore, a traveling angle of a perspective image differs between the first state in FIG. 11 and the second state in FIG. 12.

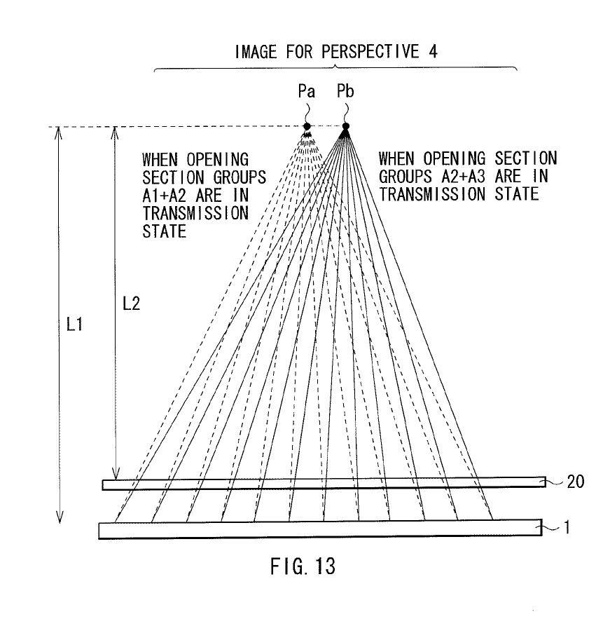

FIG. 13 illustrates states where light beams of the perspective images to which the perspective number 4 is assigned are focused on a position at the optimum viewing distance L2 in the first state in FIG. 11 and the second state in FIG. 12. At the distance L2 from the liquid crystal barrier 20, a position, in the first state, where light beams of images for a same perspective are focused differs from that in the second state. While the light beams are focused on a position Pa in the first state (when only the opening sub-section groups Al and A2 are in the transmission state), the light beams are focused on a position Pb in the second state (when only the opening sub-section groups A2 and A3 are in the transmission state). It is to be noted that a difference between the positions Pa and Pb at the optimum viewing distance L2 are insignificant to view stereoscopic display.

[Principle to Reduce Moiré]

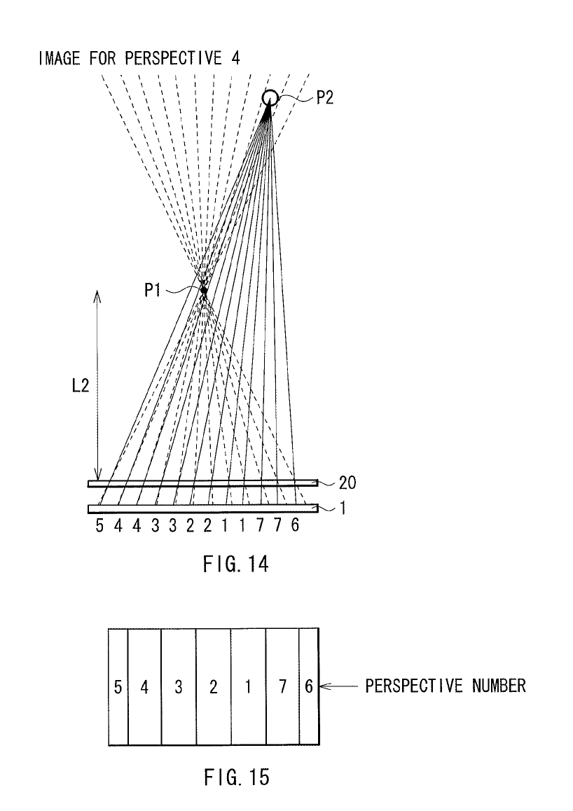

When a display operation illustrated in FIGS. 11 to 13 is performed, moiré is allowed to be reduced. Such a principle will be described below. In related art, when an image is viewed at a distance other than the optimum viewing distance L2, moiré is easily observed. For example, as illustrated in FIG. 14, when the view position P2 is located farther from the optimum viewing distance L2, for example, as illustrated in FIG. 15, one eye of the viewer views parts of a plurality of perspective images. A plurality of perspective images are mixed at a boundary between the perspective images. For example, a perspective image 3 is overlaid on a perspective image 2 around a border between the perspective images 2 and 3, thereby causing non-uniform luminance. Therefore, in related art, moiré occurs, and degradation in image quality is caused by luminance variations.

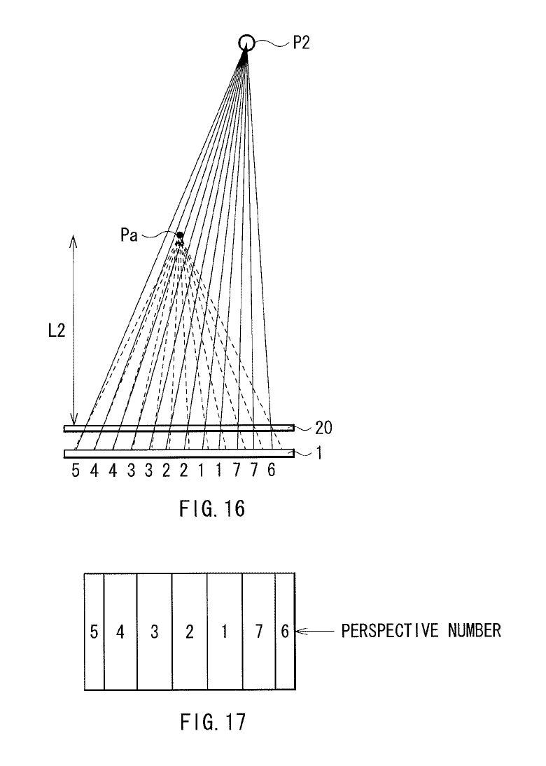

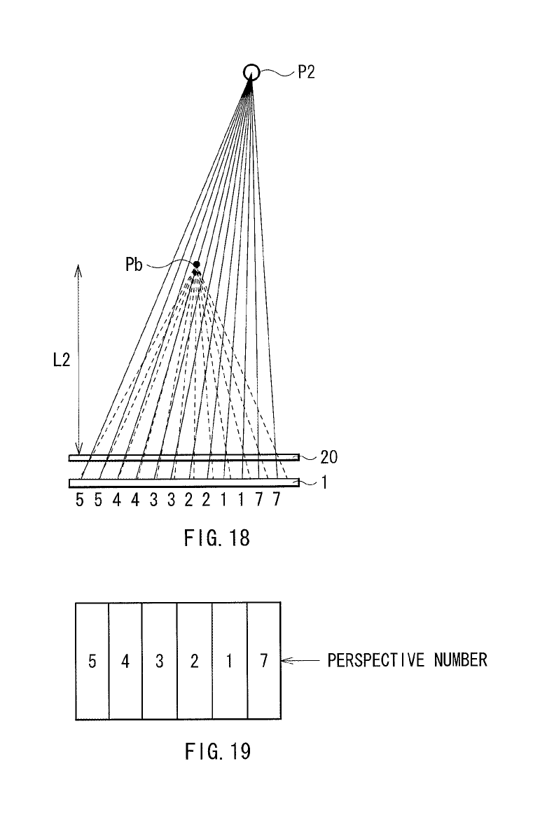

In the embodiment, moiré is reduced by switching, with time, the plurality of opening sections 21 from one state to another at high speed. FIG. 16 illustrates a light-converging state when only the opening sub-section groups A1 and A2 are in the transmission state, and FIG. 17 illustrates a state of perspective images viewed from the view position P2 located farther from the optimum viewing distance L2 when only the opening sub-section groups A1 and A2 are in the transmission state. FIG. 18 illustrates a light-converging state when only the opening sub-section groups A2 and A3 are in the transmission state, and FIG. 19 illustrates a state of perspective images viewed from the view position P2 located farther from the optimum viewing distance L2 when only the opening sub-section groups A2 and A3 are in the transmission state.

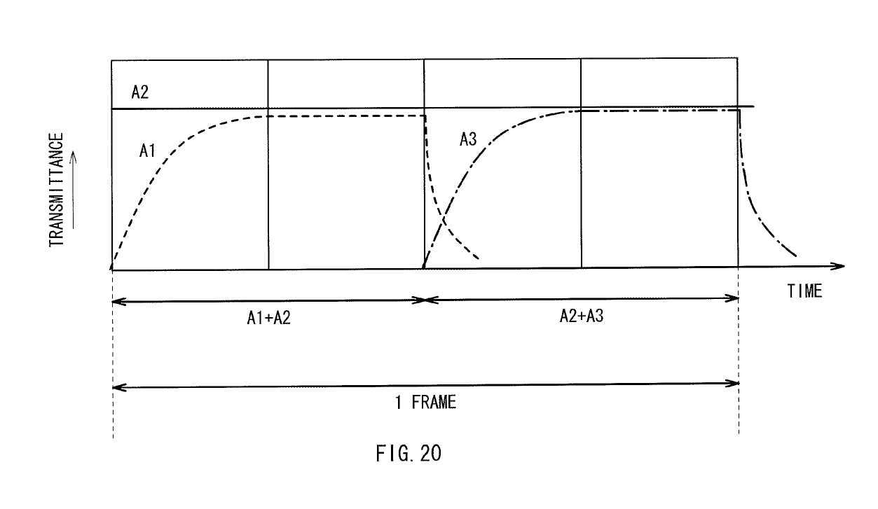

As illustrated in FIGS. 11 to 13, the traveling angles of light beams of perspective images for a same perspective differ depending on opening sub-section groups which are in the transmission state. Therefore, in an image on a screen viewed by one eye of the viewer, positions of perspective images vary with time. When only the opening sub-section groups A1 and A2 are in the transmission state, as illustrated in FIG. 17, perspective images 6, 7, 1, 2, . . . are arranged from the right in this order, and when only the opening sub-section groups A2 and A3 are in the transmission state, as illustrated in FIG. 19, perspective images 7, 1, 2, 3, . . . are arranged in this order. When switching between these two states is performed at high speed at intervals of, for example, 1/120 seconds, the viewer views an integrated image. FIG. 20 illustrates an example of variations in light transmittance of opening sub-section groups. As illustrated in FIG. 20, in each opening section 21, for example, the opening sub-section A2 located in the middle thereof is in a constant transmission state, and the opening sub-sections A1 and A3 located on the left and the right, respectively, are alternately switched into the transmission state in one frame period, thereby performing switching between the above-described two states in the opening sections 21.

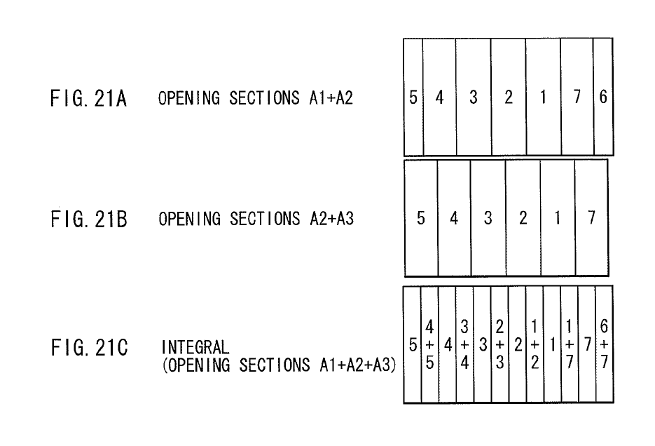

FIG. 21C illustrates an integrated image viewed by one eye of the viewer. It is to be noted that, as in the case of FIG. 17, FIG. 21A illustrates a state of perspective images viewed from the view position P2 located farther from the optimum viewing distance L2 when only the opening sub-section groups A1 and A2 are in the transmission state. FIG. 21B illustrates a state of perspective images viewed from the view position P2 when only the opening sub-section groups A2 and A3 are in the transmission state. FIG. 21C illustrates a superimposing of the state of the perspective images in FIG. 21A on the state of the perspective images in FIG. 21B.

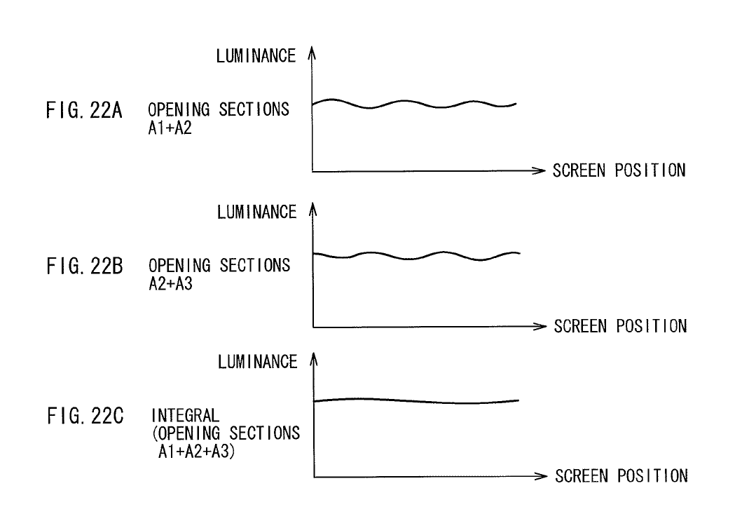

When an integrated image illustrated in FIG. 21C is viewed, luminance variations when only the opening sub-sections A1 and A2 are in the transmission state and luminance variations when only the opening sub-sections A2 and A3 are in the transmission state are also integrated. FIGS. 22A to 22C illustrate integration of these luminance variations. It is to be noted that FIG. 22A illustrates a luminance distribution viewed from the view position P2 located farther from the optimum viewing distance L2 when only the opening sub-section groups A1 and A2 are in the transmission state. FIG. 22B illustrates a luminance distribution viewed from the view position P2 when only the opening sub-section groups A2 and A3 are in the transmission state. FIG. 22C illustrates a superimposing of the luminance distribution in FIG. 22A on the luminance distribution in FIG. 22B. When the positions of the opening sections 21 which are in the transmission state vary, a boundary between perspective images varies to vary a position where luminance variations are caused; however, when these two states are integrated at high speed, luminance variations are reduced.

Thus, moiré caused by luminance variations is allowed to be reduced, thereby improving image quality. The above description indicates that the opening sub-section groups to be in the transmission state are switched from one state to another at high speed, and the speed is faster than eye response rate where a human is allowed to perceive. For example, when switching is performed at a speed of 1/25 seconds or faster, flicker is less likely to be perceived.

### [Effects]

As described above, in the display device according to the embodiment, light transmittance of each traveling angle selection section (each opening section 21) is non-uniform in time, more specifically, each traveling angle selection section includes a plurality of sub-regions (opening sub-sections), and in each traveling angle selection section, light transmittance varies with time in each of the sub-regions; therefore, an image with high image quality and less moiré is allowed to be displayed. In particular, in addition to color moiré, moiré caused by luminance variations is allowed to be reduced.

### Modification of First Embodiment

In the above-described embodiment, the case where the number n of perspectives is 7 and the opening sections 21 are switched from one of first to mth states to another, where m is 2, is described as an example; however, these parameters may have any other values. For example, each of the opening sections 21 may include three or more sub-regions (opening sub-section groups), and the opening sections 21 may be switched from one of three or more states to another. When the number of states of the opening sections 21 is increased, a position where luminance variations are caused is allowed to vary more finely, and luminance variations in these states are allowed to be integrated, thereby further reducing luminance variations. Moreover, as a difference in the position of a viewed image between the opening sub-section groups is small, a sense of flicker on the screen is suppressed.

### Second Embodiment

Next, a display device according to a second embodiment of the disclosure will be described below. It is to be noted that like components are denoted by like numerals as of the display device according to the first embodiment, and will not be further described.

In the first embodiment, each of the traveling angle selection sections (opening sections 21) includes a plurality of sub-regions (opening sub-sections), and in respective opening sections 21, light transmittance varies with time in each opening sub-section group; however, light transmittance of each opening section 21 may be non-uniform in space without varying the light transmittance with time.

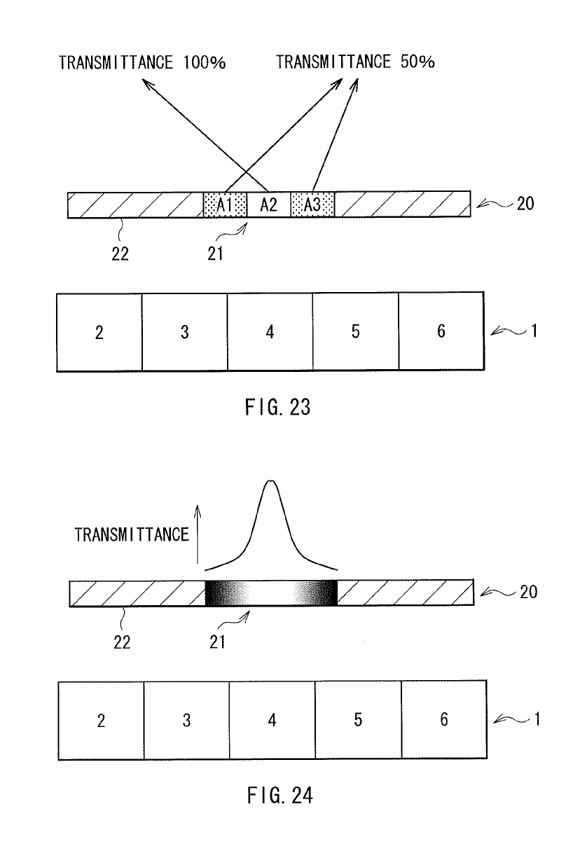

FIG. 23 illustrates a first example when light transmittance of each opening section 21 varies in space. As illustrated in FIG. 23, in each opening section 21, for example, the opening sub-section A2 located in the middle thereof constantly has a light transmittance of 100%, and the opening sub-sections A1 and A3 located on the left and the right, respectively, constantly have a light transmittance of 50%. Therefore, in each opening section 21, the light transmittances of adjacent opening sub-sections are different from each other. When each opening section 21 has a light transmittance distribution as illustrated in FIG. 23, a viewing state equivalent to a superimposing of the first state in FIG. 11 on the second state in FIG. 12 in the first embodiment is allowed to be obtained.

FIG. 24 illustrates a second example when the light transmittance of each opening section 21 varies in space. In the first example in FIG. 23, each opening section 21 has three sub-regions (opening sub-sections), and a light transmittance distribution in each opening section 21 is made non-uniform in a stepwise manner. On the other hand, in the second example in FIG. 24, a light transmittance distribution in each opening section 21 varies in a predetermined direction (a horizontal direction) in a non-stepwise manner (continuously) without providing sub-regions in each opening section 21. In the second example, a viewing state approximating to a superimposing of the first state in FIG. 1 on the second state in FIG. 12 in the first embodiment is allowed to be obtained.

As described above, in the display device according to the embodiment, the light transmittance of each traveling angle selection section (opening section 21) is allowed to be non-uniform in space; therefore, an image with high image quality and less moiré is allowed to be displayed. In particular, in addition to color moiré, moiré caused by luminance variations is allowed to be reduced. Moreover, compared to the case where the light transmittance is allowed to be non-uniform with time as in the case of the first embodiment, a brighter image is allowed to be displayed.

### Third Embodiment

Next, a display device according to a third embodiment of the disclosure will be described below. It is to be noted that like components are denoted by like numerals as of the display devices according to the first and second embodiments, and will not be further described.

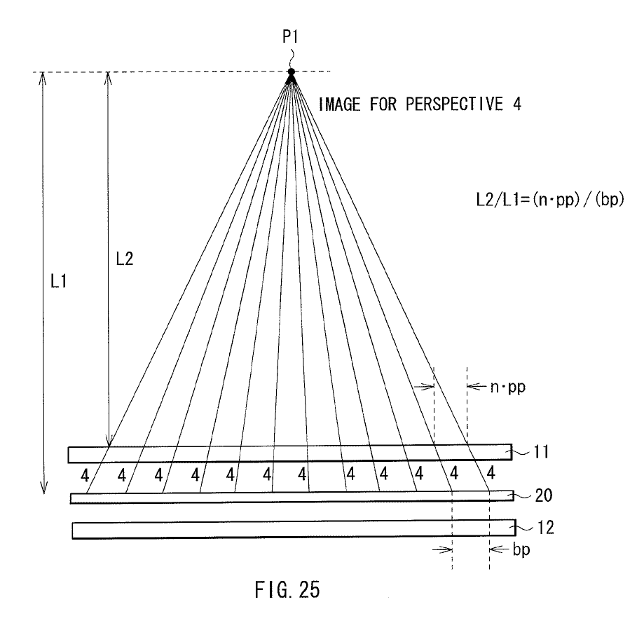

In the first embodiment, the parallax generation section 2 (the liquid crystal barrier 20) is disposed between the image display section 1(the liquid crystal panel 11) and the viewer; however, as illustrated in FIG.25, the liquid crystal panel 11 may be disposed between the liquid crystal barrier 20 and the viewer. In this case, the liquid crystal barrier 20 is disposed between the liquid crystal panel 11 and the backlight 12.

In this case, a relationship of L2/L1=(n·pp)/(bp) is established. Also in this case, n is a non-integral multiple of m, and the value of n·pp is smaller than that of bp.

### Fourth Embodiment

Next, a display device according to a fourth embodiment of the disclosure will be described below. It is to be noted that like components are denoted by like numerals as of the display devices according to the first to third embodiments, and will not be further described.

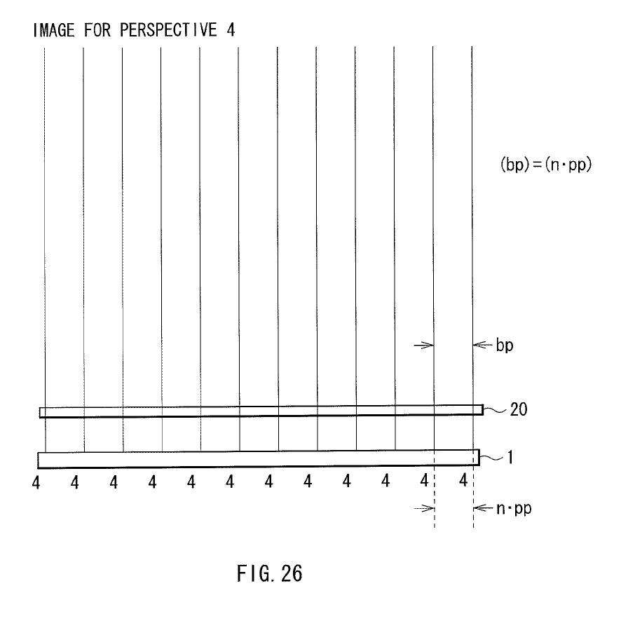

As illustrated in FIG. 26, technology of the disclosure is also applicable to an integral imaging system. In this case, (bp)=(n·pp) is established.

### Fifth Embodiment

Next, a display device according to a fifth embodiment of the disclosure will be described below. It is to be noted that like components are denoted by like numerals as of the display devices according to the first to fourth embodiments, and will not be further described.

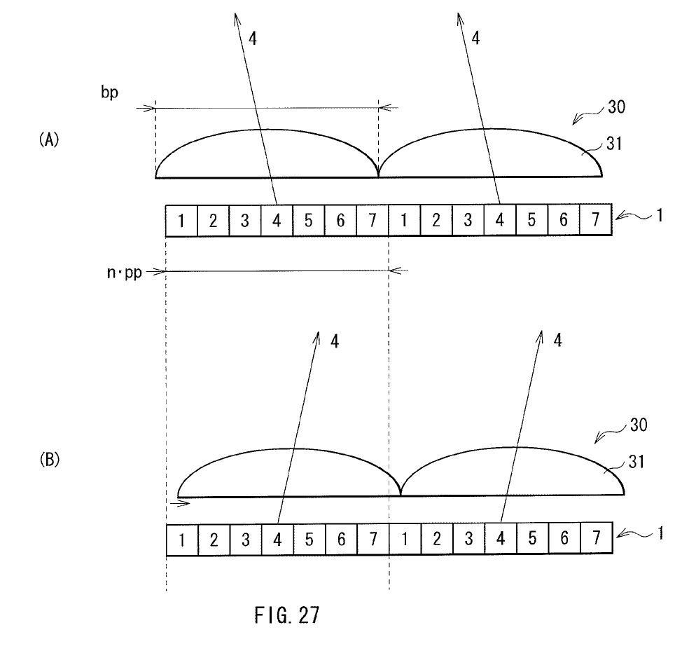

In the first embodiment, an example in which a parallax barrier (the liquid crystal barrier 20) is used as the parallax generation section 2 is described; however, as illustrated in parts (A) and (B) in FIG. 27, a lenticular lens 30 may be used as the parallax generation section 2. The lenticular lens 30 includes a plurality of cylindrical split lenses 31. The split lenses 31 each have a function as a traveling angle selection section selecting any from light of respective perspective images traveling in respective angle directions from the pixels 10 of the image display section 1 to emit the light.

In the parts (A) and (B) in FIG. 27, the case where the number n of perspectives is 7 and the split lenses 31 each are switched from one of first to mth states to another, where m is 2, is illustrated as an example. In this case, the position of each split lens 31 varies with time from one of two positions to the other as illustrated in the parts (A) and (B) in FIG. 27. The position of each split lens 31 is allowed to be physically moved at high speed by, for example, a piezoelectric device or the like. Moreover, when the split lens 31 is a liquid crystal lens formed of a liquid crystal material with use of reflective index anisotropy, the position of each split lens 31 is allowed to vary with time by a relationship between the position of a transparent electrode and an applied electric field. Moreover, a liquid lens may be used.

In the example in the parts (A) and (B) in FIG. 27, when L1 and L2 in FIG. 8 are used, L2/L1=(bp)/(n·pp) is established, where by corresponds to an interval of the split lens 31 in each of the states illustrated in the parts (A) and (B) in FIG. 27.

According to the embodiment, the lenticular lens 30 is used as the parallax generation section 2; therefore, there is an advantage that a brighter image is allowed to be displayed, compared to the case where a parallax barrier is used.

### Other Embodiments

The technology of the disclosure is not limited to those described in the above-described embodiments, and are variously modified. For example, in the first and second embodiments and the like, the opening sections 21 of the liquid crystal barrier 20 may be configured in a so-called diagonal barrier system in which the opening sections 21 are aligned not in a vertical direction but in a diagonal direction. Moreover, the opening sections 21 of the liquid crystal barrier 20 may be configured in a step barrier system. Further, in the fifth embodiment, the lenticular lens 30 may be configured in a slanted lenticular system in which the split lenses 31 are slanted.

Moreover, in the circuit in FIG. 1, left and right (LR) image signals may be supplied to the image display section drive circuit 3 as the parallax image signals S1 to produce the number n of multi-perspective images from the parallax information of the signals in the image display section drive circuit 3.

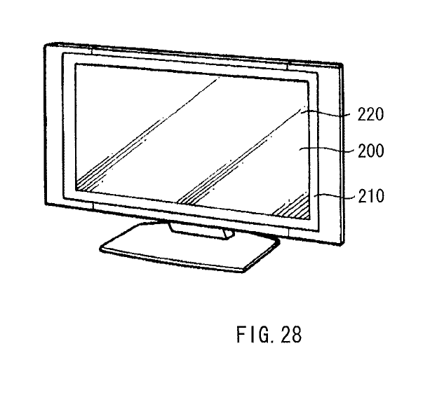

Further, any of the display devices according to the above-described respective embodiments is applicable to various electronic units having a display function. FIG. 28 illustrates an external configuration of a television as an example of such an electronic unit. The television includes an image display screen section 200 which includes a front panel 210 and a filter glass 220. Any of the display devices according to the above-described embodiments is applicable to not only the television but also various digital cameras, camcorders, cellular phones, notebook personal computers, and the like.

Further, for example, the technology is allowed to have the following configurations.

(1) A display device including:

a display section including a plurality of pixels, and displaying a plurality of perspective images assigned to the pixels; and

a plurality of selectors each selecting any from among the perspective images traveling in respective angle directions from the pixels,

in which light transmittance of each of the selectors is non-uniform in time or space.

(2) The display device according to (1), in which

each of the selectors has a plurality of sub-regions, and

light transmittance of each of the sub-regions in each of the selectors varies with time.

(3) The display device according to (1) or (2), in which

each of the selectors has first to third sub-regions, and

alternate switching between a first state and a second state is performed in each of the selectors, the first state allowing the first and second sub-regions to be switched into transmission state and allowing the third sub-region to be switched into non-transmission state, the second state allowing the second and third sub-regions to be switched into the transmission state and allowing the first sub-region to be switched into the non-transmission state.

(4) The display device according to any of (1) to (3), in which

a traveling angle direction of a perspective image is allowed to vary with time through controlling the light transmittance of the selectors, independently of one another, to vary with time.

(5) The display device according to (1), in which

each of the selectors has a plurality of sub-regions, and

light transmittances of adjacent sub-regions in each of the selectors are different from each other.

(6) The display device according to (1), in which

light transmittance in each of the selectors varies with spatial continuity in a predetermined direction.

(7) The display device according to any of (1) to (6), including a parallax barrier having a plurality of openings,

in which the openings function as the selectors, respectively.

(8) The display device according to (1), further including a lenticular lens including a plurality of lens elements,

in which the lens elements function as the selectors, respectively.

(9) The display device according to any of (1) to (8), in which

the selectors are disposed between the display section and a viewer.

(10) The display device according to any of (1) to (8), in which

the display section is disposed between the selectors and a viewer.

(11) An electronic unit including a display device, the display device including:

a display section including a plurality of pixels, and displaying a plurality of perspective images assigned to the pixels; and

a plurality of selectors each selecting any from among the perspective images traveling in respective angle directions from the pixels,

in which light transmittance of each of the selectors is non-uniform in time or space.

The present application contains subject matter related to that disclosed in Japanese Priority Patent Application 2011-187456 filed in the Japan Patent Office on Aug. 30, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display device comprising:
a display section including a plurality of pixels, and displaying a plurality of perspective images assigned to the pixels; and
a plurality of selectors each selecting any from among the perspective images traveling in respective angle directions from the pixels,
wherein light transmittance of each of the selectors is non-uniform in time or space.

2. The display device according to claim 1, wherein
each of the selectors has a plurality of sub-regions, and
light transmittance of each of the sub-regions in each of the selectors varies with time.

3. The display device according to claim 2, wherein
each of the selectors has first to third sub-regions, and
alternate switching between a first state and a second state is performed in each of the selectors, the first state allowing the first and second sub-regions to be switched into transmission state and allowing the third sub-region to be switched into non-transmission state, the second state allowing the second and third sub-regions to be switched into the transmission state and allowing the first sub-region to be switched into the non-transmission state.

4. The display device according to claim 1, wherein
a traveling angle direction of a perspective image is allowed to vary with time through controlling the light transmittance of the selectors, independently of one another, to vary with time.

5. The display device according to claim 1, wherein
each of the selectors has a plurality of sub-regions, and
light transmittances of adjacent sub-regions in each of the selectors are different from each other.

6. The display device according to claim 1, wherein
light transmittance in each of the selectors varies with spatial continuity in a predetermined direction.

7. The display device according to claim 1, comprising a parallax barrier having a plurality of openings,
wherein the openings function as the selectors, respectively.

8. The display device according to claim 1, comprising a lenticular lens including a plurality of lens elements,
wherein the lens elements function as the selectors, respectively.

9. The display device according to claim 1, wherein
the selectors are disposed between the display section and a viewer.

10. The display device according to claim 1, wherein
the display section is disposed between the selectors and a viewer.

11. An electronic unit including a display device, the display device comprising:
a display section including a plurality of pixels, and displaying a plurality of perspective images assigned to the pixels; and
a plurality of selectors each selecting any from among the perspective images traveling in respective angle directions from the pixels,
wherein light transmittance of each of the selectors is non-uniform in time or space.
